(19) United States
(12) Patent Application Publication
(10) Pub. No.: US 2019/0236581 A1
(43) Pub. Date: Aug. 1, 2019

(54) METHOD AND SYSTEM FOR EXCHANGING A PHYSICAL ARTICLE IN A DRIVE-THROUGH LANE

(71) Applicant: Diebold Nixdof, Incorporated, North Canton, OH (US)

(72) Inventors: Douglas Kurt HARTUNG, Kingwood, TX (US); Gregory Shimek, Akron, OH (US); Gary A. Ganger, Uniontown, OH (US)

(21) Appl. No.: 16/235,254

(22) Filed: Dec. 28, 2018

Related U.S. Application Data
(60) Provisional application No. 62/623,557, filed on Jan. 30, 2018.

(51) Int. Cl. G06Q 20/32; G06Q 20/10; G06Q 20/40

(52) U.S. Cl. CPC G06Q 20/3223; G06Q 20/1085; G06Q 20/204; G06Q 20/3278; G06Q 20/4012; G06Q 20/3274

(57) ABSTRACT

A method and system for linking transaction information provided prior to or upon arrival at the drive-through lane with a computing device in a drive-through is disclosed herein. A first input is received at a first computing device from second computing device of a user. The first input includes details of an exchange of a physical article and an account associated with the user. Subsequently, a second input is received by first computing device that includes the account and data associated with an exchange location. A third computing device is positioned along a drive-through lane at the exchange location. The first computing device communicates at least part of the first input to the third computing device in response to the receiving the second input. A physical article is exchanged with the user in response to the first input.

### CROSS-REFERENCE TO RELATED APPLICATIONS

This application claims the benefit of U.S. Provisional Patent Application Ser. No. 62/623,557 for a METHOD AND SYSTEM FOR LINKING A PRE-STAGED TRANSACTION WITH A DRIVE-THROUGH LANE, filed on Jan. 30, 2018, which is hereby incorporated by reference in its entirety.

### BACKGROUND

This relates in general to methods and systems for completing transactions in a drive-through lane.

A drive-through lane allows an individual to conduct a transaction while seated in a vehicle. The transaction begins when a first individual communicates the details of the desired transaction to a second individual. The details can be communicated face-to-face, or through a system including at least one microphone and at least one speaker. Vehicles can form a line and move in one direction through the drive-through.

### SUMMARY

This relates more particularly to a method for linking transaction information provided prior to or upon arrival at the drive-through lane. The method includes receiving, at a first computing device having one or more processors, a first input from a second computing device having one or more processors. The second computing device can be remote from the first computing device and be possessed by a user. The first input can include details of an exchange of a physical article performed at an exchange location having a drive-through lane. The first input can also include an account associated with the user. The method also includes storing, with the first computing device, the first input in a database. The method also includes positioning a third computing device having one or more processors along a drive-through lane at the exchange location. The method also includes receiving, at the first computing device, a second input including the account associated with the user. Also, the second input is indicative that the user is positioned at the exchange location. The method also includes retrieving, at the first computing device, the first input from the database in response to the receiving the second input. The method also includes communicating, with the first computing device, at least part of the first input to the third computing device in response to the receiving the second input. The method also includes exchanging, with the third computing device, the physical article.

According to other features, the method can also include positioning a physical object in the drive-through lane at the exchange location. The method can also include scanning, with the second computing device, at least part of the physical object. The method can also include generating, at the second computing device, the second input in response to the scanning. The positioning can be further defined as positioning a quick response code on the physical object in the drive-through lane at the exchange location.

In other features, the method can also include positioning a near field communication device along the drive-through lane at the exchange location. The method can also include receiving, with the near field communication device, a signal including the account associated with the user from the second computing device. The method can also include communicating, with the near field communication device, the account associated with the user to the third computing device.

According to additional features, the method can also include positioning a near field communication device along the drive-through lane at the exchange location. The method can also include emitting, with the near field communication device, a signal including the exchange location. The method can also include wherein the receiving the second input at the first computing device is further defined as receiving the second input from the second computing device.

According to other features, the receiving of the second input at the first computing device can be further defined as receiving the second input from the second computing device. Also, the exchange location can be undetermined by the first computing device immediately after said receiving the first input. The second input can be at least partially received from the second computing device at the exchange location and the second input can include data associated with the exchange location.

In other features, the method can also include exchanging, with the third computing device, the physical article with the user in response to the communicating the first input to the third computing device by the first computing device. The exchanging can be further defined as receiving, with the second computing device, the physical article from the user. Alternatively, the exchanging can be further defined as dispensing, with the second computing device, the physical article to the user.

The exchanging can be further defined as exchanging, with the third computing device, the physical article with the user in response to the communicating the first input to the third computing device by the first computing device without further authentication of the user. Alternatively, the method can also include authenticating, with the third computing device, the user prior to the exchanging and subsequent to the communicating the first input to the third computing device, the authenticating in response to details of the exchange of the physical article. The authenticating can be further defined as receiving, at the third computing device, a Personal Identification Number (PIN) number from the user. The authenticating can be further defined as receiving, at the third computing device, a card and a PIN number from the user. The authenticating can be further defined as receiving, at the first computing device, a third input from the second computing device.

According to additional features, the method can also include receiving, at the first computing device, a third input from the second computing device substantially concurrent with the first input, the second input indicating a current location of the user. The method can also include determining, at the first computing device, one or more possible exchange locations proximate to the second computing device. The method can also include transmitting, with the first computing device, a message to the second computing device of the one or more possible exchange locations.

This disclosure also relates more particularly to a system configured to link transaction information provided prior to or upon arrival at the drive-through lane. The system includes a first computing device having one or more processors and a non-transitory, computer readable medium. The first computing device can be configured to communicate with a remote, second computing device possessed by a user. The system also includes a third computing device having one or more processors and a non-transitory, computer readable medium. The third computing device can be positioned along a drive-through lane at an exchange location remote from the first computing device. The non-transitory, computer readable medium of the first computing device stores instructions that, when executed by the one or more processors, cause the first computing device to perform operations including: receiving a first input from the second computing device, the first input including details of the exchange of the physical article performed after receiving the first input and performed at an exchange location. The first input can also include an account associated with the user. The first computing device can also store the first input in a database. The first computing device can also receive a second input including the account associated with the user and data associated with the exchange location. The second input can be indicative that the user is positioned at the exchange location. The first computing device can also retrieve the first input from the database in response to receiving the second input and communicating at least part of the first input to the third computing device in response to receiving the second input.

In other features, the system can also include a locating marker positioned along the drive-through lane at the exchange location remote from the first computing device. The locating marker can be configured to convey details of the exchange location. The locating marker can be a quick response code for scanning by the second computing device by the user when the user is in the drive-through lane. Alternatively, the locating marker can be a near field communication device for communicating with the second computing device when the user is in the drive-through lane.

According to other features, the locating marker can be physically-spaced along the drive-through lane from the third computing device whereby the user is not able to engage the locating marker and the third computing device from the vehicle at the same position along the drive-through lane.

Various aspects will become apparent to those skilled in the art from the following detailed description and the accompanying drawings.

### BRIEF DESCRIPTION OF THE DRAWINGS

FIG. 1 is a functional block diagram of an exemplary system according to one or more implementations of the present disclosure;

FIG. 2 is a flow diagram of an exemplary method executed by a first computing device according to one or more implementations of the present disclosure;

FIG. 3 is a flow diagram of an exemplary method executed by a second computing device according to one or more implementations of the present disclosure;

FIG. 4 is a flow diagram of an exemplary method executed by a third computing device according to one or more implementations of the present disclosure;

FIG. 5 is a perspective view of a user scanning a quick response code in a drive-through lane prior to interacting with an automated transaction machine (ATM); and

FIG. 6 is a perspective view of a user tapping a near field communication device in a drive-through lane prior to interacting with an ATM.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

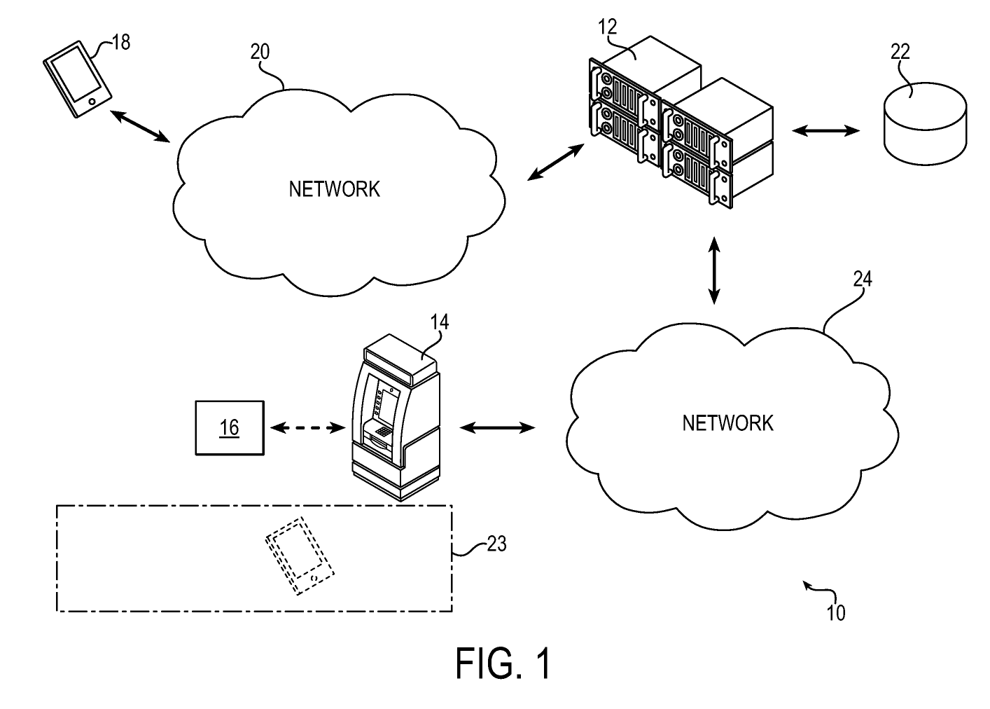

Referring now to the drawings, there is illustrated in FIG. 1 a functional block diagram of an exemplary system according to one or more implementations of the present disclosure. An exemplary system 10 is configured to link transaction information provided prior to or upon arrival at the drive-through lane. In one or more other implementations of the present disclosure, a system can be configured to link pharmacy transaction information provided prior to or upon arrival with a computing device in a drive-through. For example, a user can retrieve a prescription using an embodiment of the present disclosure. In one or more other implementations of the present disclosure, a system can be configured to link consumer-good transaction information provided prior to or upon arrival with a computing device in a drive-through. For example, a user can retrieve groceries or prepared food using an embodiment of the present disclosure. Goods other than food can be retrieved by a user in other embodiments. A user can be a consumer or a commercial entity. For example, one or more other implementations of the present disclosure can be applied at a loading dock of a distribution facility. In such an embodiment, a user would be a truck driver delivering goods to the distribution facility or picking up goods from the distribution facility. Generally, the present disclosure is desirable to enhance a flow of vehicle movement at drive-through lanes of any kind.

The exemplary system 10 includes a first computing device 12, a third computing device 14, and a locating marker 16. The exemplary system 10 interacts with a remote, second computing device 18 possessed by a user. The system 10 can be operated by a financial institution and the user can be an account holder of the financial institution. In other implementations of the present disclosure, by way of example and not limitation, a system can be operated by a merchant of consumer goods, a provider of healthcare-related products, or a delivery company.

The exemplary first computing device 12 has one or more processors and a non-transitory, computer readable medium. The first computing device 12 can be a server computing device. The exemplary first computing device 12 is configured to communicate with the remote, second computing device 18 possessed by a user. The first computing device 12 can be configured to communicate with the second computing device 18 over a network 20. The network 20 can include a local area network (LAN), a wide area network (WAN), e.g., the Internet, or any combination thereof. The network 20 can be wireless, wired, or any combination thereof. This aspect of the present disclosure is well suited to a wide variety of computer network systems over numerous topologies. The exemplary first computing device 12 can also access a database 22. The database 22 and the first computing device 12 can be interconnected over a LAN or a WAN.

The exemplary third computing device 14 has one or more processors and a non-transitory, computer readable medium. The exemplary third computing device 14 is an ATM, which includes a PC. It is noted that in other implementations of the present disclosure the third computing device could be a teller terminal, a point of sale (POS) device, or a PC running a custom computer application (APP). The exemplary third computing device 14 is positioned along a drive-through lane (referenced at 23) at an exchange location remote from the first computing device 12. The drive-through lane 23 is traversable by a vehicle so that the user, while operating a vehicle, can drive along the lane 23 and can interact with the locating marker 16 and the ATM 14 without exiting the vehicle. The third computing device 14 can include a screen to display information to the user, a keypad to allow the user to enter a PIN, a card receiver to receive the card of the user, and one or more mechanisms to execute an exchange with the user. For example, the third computing device 14 can also include an intake device to receive deposits from the user and a dispenser to dispense cash to the user. The intake device and the dispenser may be one, integral device in one or more embodiments of the present disclosure.

The first computing device 12 and the third computing device 14 can communicate with one another over a network 24. The network 24 can be a WAN. It is noted that the exemplary network 24 can be more secure than the exemplary network 20. However, it is noted that in one or more alternative embodiments of the present disclosure the first computing device 12 and the third computing device 14 can communicate with one another over the network 20.

The exemplary locating marker 16 is positioned along the drive-through lane 23 at the exchange location, which is remote from the first computing device 12. The exemplary locating marker 16 is configured to convey details of the exchange location, the location of the ATM 14. For example, the locating marker 16 can include a quick response (QR) code. The QR code can contain data indicative of the location of the ATM 14. The appearance of the QR code is configured to particularly identify the exchange location from a plurality of different, possible exchange locations. The scanning of the QR code and the transmission of the data contained in the QR code indicates that the user is positioned at the drive-through lane 23 of the exchange location. The QR code can be scanned with the second computing device 18 by the user when the user is in the drive-through lane 23. The scanning of the QR code can be completed through an APP operating on the second computing device 18, wherein the APP is at least partially controlled by the financial institution, such as a mobile banking APP. In response to scanning the QR code, the second computing device 18 can be controlled by the APP to transmit the exchange location to the first computing device 12. The exchange location can be part of the data transmitted as part of an input to the first computing device 12. The APP can retain the user's account data and the account associated with the user can be transmitted by the second computing device 18 in combination with the exchange location.

In another non-limiting embodiment, the locating marker 16 can include a near field communication (NFC) device. The NFC device can communicate with the second computing device 18 when the user is in the drive-through lane 23. The NFC device can be a “dumb” NFC device that can transmit details of the exchange location when the user taps the second computing device 18 on the NFC device. Upon receipt of the exchange location, the second computing device 18 can transmit the input to the first computing device 12, which includes the exchange location and the account associated with the user. Alternatively, the NFC device can be a “smart” NFC device that can receive details of the user's account from the second computing device 18 when the user taps the second computing device 18 on the NFC device. In such an embodiment, the smart NFC can then transmit the details of the user's account to the first computing device 12 or to the third computing device 14.

It is noted that a QR code and an NFC device are presented as examples and are not limiting on the present disclosure. For example, in another non-limiting embodiment, the locating marker 16 can include one or more Bluetooth® beacons. The one or more Bluetooth® beacons can communicate with the second computing device 18 when the user is in the drive-through lane 23. As with the NFC device, the communication between the second computing device 18 and the Bluetooth® beacons can involve the second computing device 18 receiving data of the exchange location and transmitting the data to the first computing device 12 as part of an input or the one or more Bluetooth® beacons receiving the user account data from the second computing device and communicating the data to the third computing device 14. In another non-limiting embodiment, the locating marker 16 can include geo-fencing. For example, the geo-fencing can be utilized with a banking APP operating on the second computing device 18. In another non-limiting embodiment, the locating marker 16 can include structures for biometric identification. Fingerprint or facial recognition are two examples of such identification. In another non-limiting embodiment, the locating marker 16 can include magnetic coupling, such as disclosed in EP0598528A2.

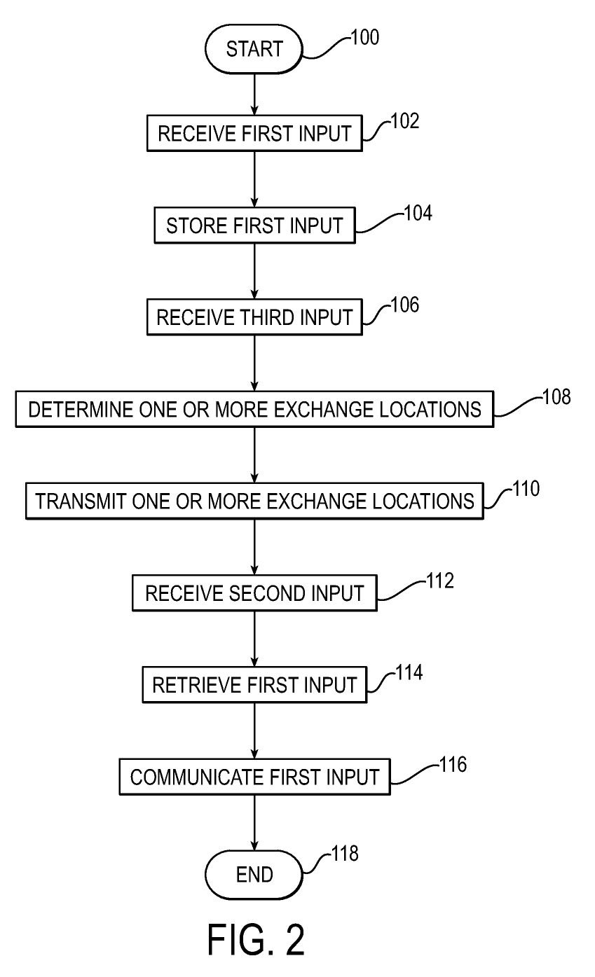

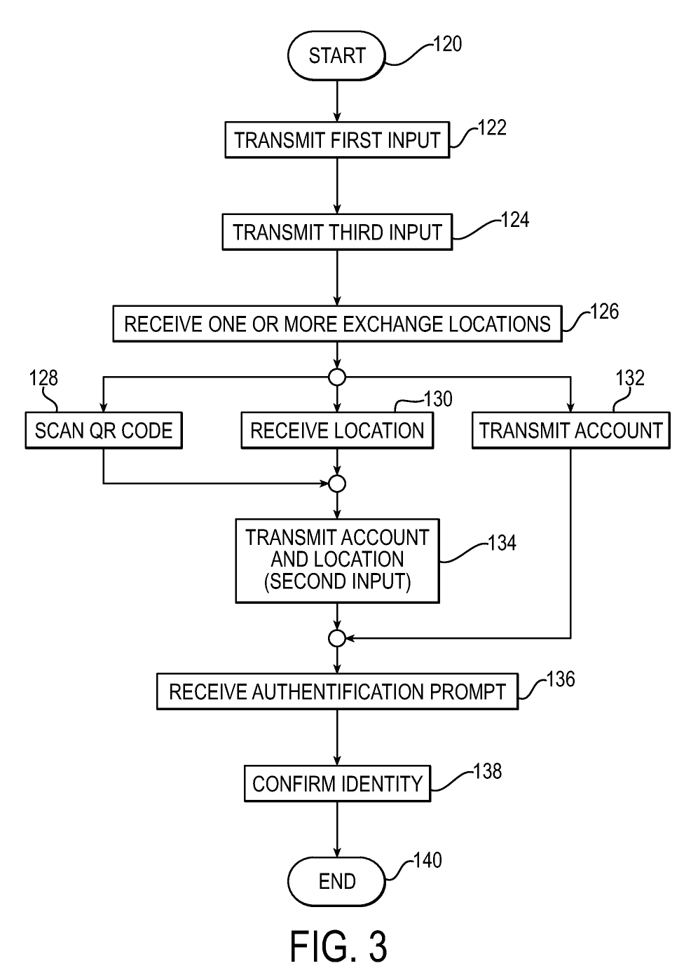

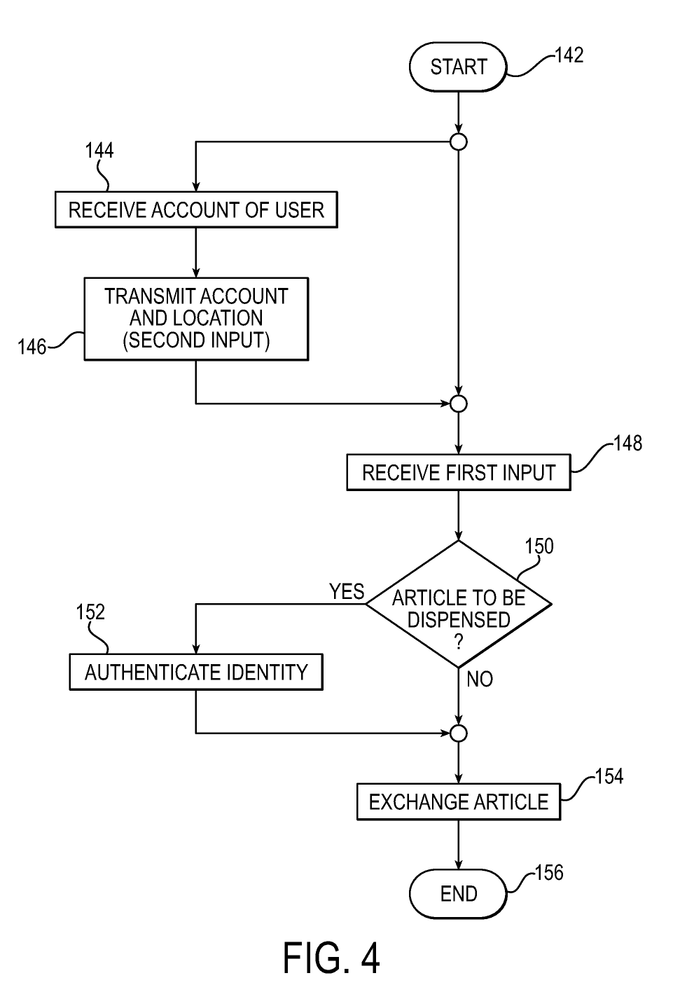

In operation, the system 10 can execute a method for linking a pre-staged banking transaction with a computing device associated with an ATM in a drive-through. In other implementations of the present disclosure, a computing device may be a teller terminal or POS terminal inside a brick and mortar building. FIGS. 2-4 are flow diagrams of exemplary actions of the various computing devices. FIG. 2 is a flow diagram of an exemplary method executed by the first computing device 12 according to one or more implementations of the present disclosure and starts at 100. FIG. 3 is a flow diagram of an exemplary method executed by the second computing device 18 according to one or more implementations of the present disclosure and starts at 120. FIG. 4 is a flow diagram of an exemplary method executed by the third computing device 14 according to one or more implementations of the present disclosure and starts at 142.

As shown in FIG. 3 at 122, the second computing device 18 can generate and transmit the first input. As shown in FIG. 2 at 102, the first computing device 12 can receive the first input. The second computing device 18 can be executing an APP at least partially controlled by the financial institution, such as a mobile banking APP. The user can use the APP to initiate the transmission of the first input and send the first input with the second computing device 18. The first input is stored in the database 22 by the first computing device 12. The first input can include details of an exchange of a physical article that will be performed after the first input is received. The details of the exchange can include the nature of the exchange and the value or amount of the exchange. For example, the physical article can be a check and the exchange can be the depositing of the check of some amount in the ATM 14 by the user. Alternatively, the physical article can be currency and the exchange can be the withdrawal of some amount of currency from the ATM 14 by the user. It is noted that in other implementations of the present disclosure, the physical exchange may be via a vacuum tube or hand to hand exchange through a window.

The exchange location is unknown to the first computing device 12 when the first input is received, in one or more implementations of the present disclosure. The first computing device 12 can optionally assist the user in determining the exchange location. At 124 in FIG. 3, the second computing device 18 can transmit another input, a third input, that is received by the first computing device 12, as shown at 106 in FIG. 2. The third input can indicate a current location of the user. The mobile banking APP operating on the second computing device 18 can be configured to access the GPS data retained in the second computing device 18 and transmit that data to the first computing device 12 with the first input. The third input can thus be transmitted substantially concurrent with the first input. In response to receiving the third input, the first computing device 12 can determine one or more possible exchange locations proximate to the current location. For example, a look-up table or listing of the geographic locations of available ATMs can be stored in the database 22 and the first computing device 12 can access the database 22. Based on the current location, at 108, the first computing device 12 can identify proximate ATMs from the database 22. At 110 in FIG. 2, the first computing device 12 can transmit one or more locations for consideration by the user, which is received by the second computing device 18, as shown at 126 in FIG. 3.

The mobile banking APP operating on the second computing device 18 can cause the one or more possible exchange locations, received from the first computing device 12, to be displayed on the second computing device 18. The user can select one of the possible exchange locations by pressing the desired exchange location appearing on the screen of the second computing device 18. The mobile banking APP can then access a map/directions APP on the second computing device 18 and cause directions to be displayed to the user.

Referring again to FIG. 2, the first computing device 12 can receive a second input at 112. The second input can include the identity of the user and data associated with a chosen exchange location. The data can include the geographic location of the ATM 14 or can be some other value uniquely associated with the ATM 14 such that the first computing device 12 can identify the ATM 14 from among a plurality of ATMs. As shown in FIG. 3 at 134, the second computing device 18 can generate and transmit the second input. Alternatively, as shown in FIG. 4 at 146, the third computing device 14 can generate and transmit the second input.

In one embodiment of the present disclosure, the second input is generated by the second computing device 18 without data from the third computing device 14. The second input can thus originate from the second computing device 18. A physical object can be positioned in the drive-through lane 23 at the exchange location. The physical object can be a structure displaying a QR code. Generation of the second input can begin when the user arrives at the drive-through lane 23 and scans the QR code with the second computing device 18, as referenced at 128 in FIG. 3. The data represented by the QR code can include the data associated with the exchange location. The mobile banking APP operating on the second computing device 18 can control the scanning operation and transmit the second input over the network 20. Thus, in this embodiment, the second input is received by the first computing device 12 directly from the second computing device 18 while the second computing device 18 is positioned at the exchange location, in response to the scanning of the QR code. The third computing device 14 is bypassed relative to the transmitting of the second input to the first computing device 12. As noted above, in other implementations of the present disclosure, different approaches can be applied to determine when the user has arrived at the exchange location, including Bluetooth® beacons, geo-fencing, biometric devices, and magnetic coupling.

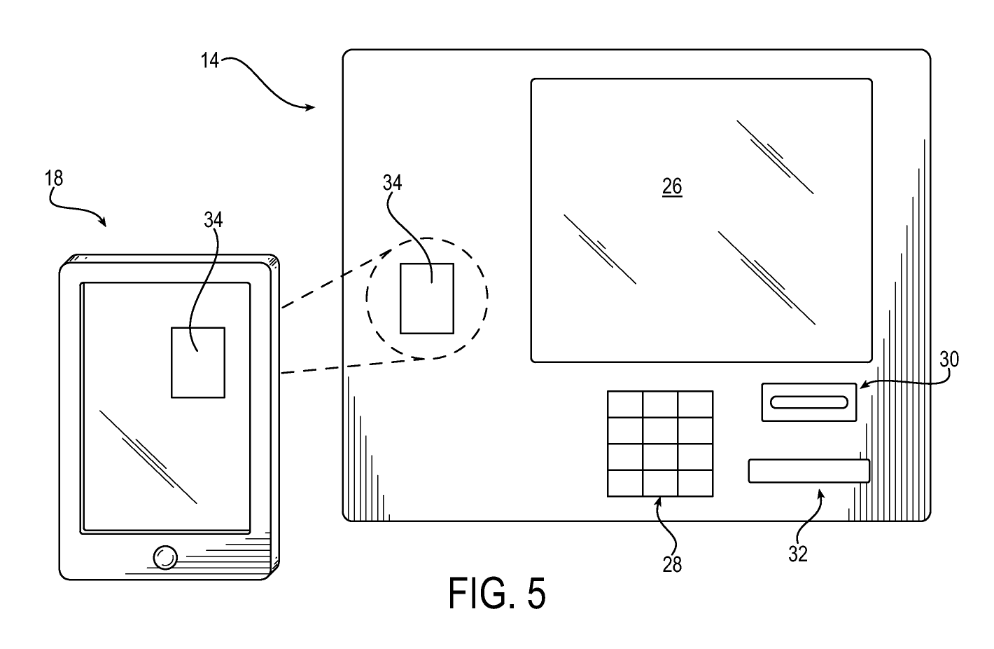

FIG. 5 illustrates an exemplary second computing device 18 and an exemplary third computing device 14. The exemplary second computing device 18 is a smartphone possessed by a user. The exemplary third computing device 14 is an ATM. The exemplary ATM 14 includes a screen 26 to display information to the user, a keypad 28 to allow the user to enter a PIN, a card receiver 30 to receive the card of the user, and an integral intake/dispenser 32 to execute an exchange with the user. A QR code 34 is being scanned by the second computing device 18 in advance of sending the second input to the first computing device 12.

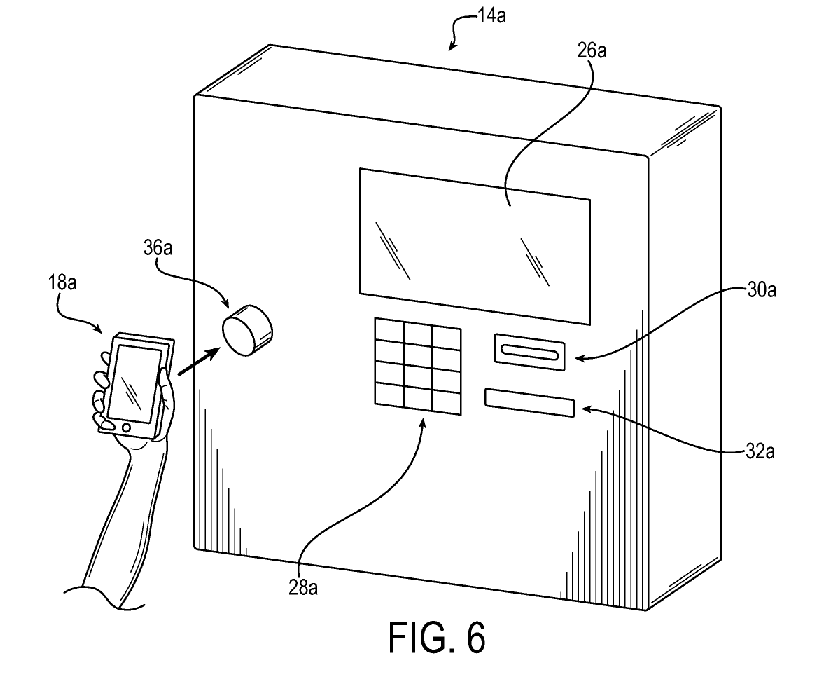

In another embodiment of the present disclosure, the second input is generated by the second computing device 18 with data from the third computing device 14 and the second input originates from the second computing device 18. Referring now to FIG. 3, at 130, the second computing device 18 can receive location data from the third computing device 14 for generating the second input. FIG. 6 illustrates another embodiment of the present disclosure wherein an exemplary second computing device 18a and an exemplary third computing device 14a. The second computing device 18a is a smartphone possessed by a user. The third computing device 14a is an ATM. The exemplary ATM 14a includes a screen 26a to display information to the user, a keypad 28a to allow the user to enter a PIN, a card receiver 30a to receive the card of the user, and an integral intake/dispenser 32a to execute an exchange with the user.

An exemplary near field communication (NFC) device 36a is positioned on the third computing device 14a, which is positioned in the drive-through lane at the exchange location. The exemplary NFC device 36a is configured to emit a signal including the exchange location. The user can “tap” the NFC device 36a with the second computing device 18a. During proximity between the NFC device 36a and the second computing device 18a, the NFC device 36a can transmit a signal to the second computing device 18a. The signal can include the exchange location. The second computing device 18a can be operating the mobile banking APP during this process. The mobile banking APP can act in response to the signal received from the NFC device 36a by packaging the location data from the signal with the account associated with the user to generate and transmit the second input directly to the first computing device 12, as referenced at 134 in FIG. 3. The third computing device 14 can thus be bypassed relative to transmitting the second input. The second computing device 18a can transmit the second input over a network that is at least partially wireless.

In another embodiment of the present disclosure, the second input is generated by the third computing device 14 with data from the second computing device 18. Referring again to FIG. 3, at 132, the second computing device 18 can transmit account data to the third computing device 14 for the third computing device 14 to generate and transmit the second input. The exemplary near field communication (NFC) device 36a positioned on the third computing device 14a can be configured to receive data. The user can tap the NFC device 36a with the second computing device 18a and, during proximity between the NFC device 36a and the second computing device 18a, the NFC device 36a can receive a signal from the second computing device 18a. The signal can include the account associated with the user as referenced at 132 in FIG. 3. The second computing device 18a can be operating the mobile banking APP during this process. The mobile banking APP can act on the signal received from the NFC device 36a requesting the account data and respond with the requested data. The NFC device 36a can direct the account data to the third computing device 14a. The third computing device 14a can receive the account data as referenced at 144 in FIG. 4. The third computing device 14a can retain in memory the exchange location data, package the exchange location data with the account associated with the user, and generate and transmit the second input directly to the first computing device 12, as referenced at 146 in FIG. 4. In this embodiment, the second input is at least partially received from the second computing device 18 at the exchange location since the part of the data of the second input is received from the second computing device 18. The account associated with the user is received by the first computing device 12 indirectly from the second computing device 18a through the third computing device 14a at the exchange location.

Referring again to FIG. 2, the first computing device 12 can retrieve the first input at 114 in response to receiving the second input at 112. The first computing device 12 can communicate at least part of the first input to the third computing device 14 in response to the receiving the second input, as referenced at 116 in FIG. 2. In embodiments in which the second input has been received by the first computing device 12 from the second computing device 18, the first computing device 12 can transmit all of the first input to the third computing device 14. In embodiments in which the second input has been received by the first computing device 12 from the third computing device 14, the first computing device 12 can transmit part of the first input. In such embodiments, the third computing device 14 has already obtained the account associated with the user. If the entirety of the first input is not communicated to the third computing device 14, the part of the first input that is communicated from the first computing device 12 to the third computing device 14 can be the nature of the exchange, whether the third computing device 14 will receive the article from the user or dispense the article to the user. The part of the first input that is communicated can also include the account associated with the user and the amount of transaction. As shown in FIG. 2, after 116, the exemplary actions of the first computing device 12 end at 118.

As shown in FIG. 4, the third computing device 14 can receive the first input (or the portion of the first input) at 148. The third computing device 14 can exchange the physical article with the user in response to the receiving the first input from the first computing device 12, as referenced at 154. The third computing device 14 can receive the physical article from the user, such as a check for deposit. Alternatively, the third computing device 14 can dispense the physical article to the user. By way of example and not limitation, the third computing device 14 can dispense one or more bank notes to the user.

The locating marker 16 can be physically-spaced along the drive-through lane 23 from the third computing device 14 whereby the user is not able to engage the locating marker 16 and the third computing device 14 from the vehicle at the same position along the drive-through lane 23. This would enhance the flow of vehicle traffic through the drive-through lane 23. The user can engage the locating marker 16 with the second computing device while a secondary user is engaging the ATM 14. The second input can be sent to the first computing device 12 and the first computing device 12 can send the first input to the ATM 14 while the ATM 14 is assisting a secondary user. When the secondary user moves his/her vehicle out of the drive-through lane 23, the user can move his/her vehicle forward from the locating marker 16 and engage the ATM 14, which has already received the first input.

Prior to exchanging the physical article with the user and after receipt of the second input by the first computing device, the system 10 may or may not take further steps to authenticate the user, as shown by the query at 150. For example, if the exchange involves a deposit, the third computing device 14 can proceed from 150 to 154. Alternatively, if the exchange involves a withdrawal, the third computing device 14 can proceed from 150 to 152 and further authenticate the user.

In one or more embodiments of the present disclosure, the third computing device 14 can require the user to enter a card and a PIN in order to authenticate the user. In other embodiments of the present disclosure, the third computing device 14 may only require the user to enter a PIN. In other embodiments of the present disclosure, the first computing device 12 can be configured to transmit a prompt to the second computing device 18 for authentication. For example, the second computing device 18 can receive a prompt through the mobile banking APP to confirm that the exchange should occur, as referenced at 136 in FIG. 3. The prompt can be displayed as one or more buttons through the mobile banking APP on the user's second computing device 18, such as a “yes” button that the exchange is being carried out by the user. The prompt can be a text message with a PIN number that can be entered at the third computing device 14. At 138, the user can confirm his or her identity and proceed with the exchange. The user's response to the prompt is another input to either the first computing device 12 or the third computing device 14. If the user's response to the prompt is transmitted to the first computing device 12, the first computing device 12 can communicate the user's response to the authentication prompt further, to the third computing device 14. The exemplary processes set forth in FIGS. 3 and 4 respectively end at 140 and 156.

In other implementations of the present disclosure, by way of example and not limitation, the third computing device 14 can be utilized by a human operator that completes the exchange with the user. In the embodiment described above, the first computing device 12 can transmit a command to the third computing device 14 to complete the exchange. In other embodiments, the first computing device 12 can transmit a signal to the third computing device 14 authorizing the exchange and the third computing device 14 can communicate the authorization to the human operator. The human operator can be a pharmacist that directs the article (medication) to the user through a window or vacuum tube. Alternatively, the human operator can load a trailer attached to the user's truck.

While principles and modes of operation have been explained and illustrated with regard to particular embodiments, it must be understood, however, that this may be practiced otherwise than as specifically explained and illustrated without departing from its spirit or scope.

What is claimed is:

1. A method for exchanging a physical article in a drive-through lane comprising:
receiving, at a first computing device having one or more processors, a first input from a second computing device, the second computing device remote from the first computing device and possessed by a user, the first input defining the pre-staged transaction and including details of an exchange of a physical article at an exchange location having a drive-through lane, and the first input also including an account associated with the user;
storing, with the first computing device, the first input in a database;
positioning a third computing device, having one or more processors, at the exchange location along the drive-through lane;
receiving, at the first computing device, a second input including the account associated with the user and the second input also indicative of the user positioned at the exchange location;
retrieving, with the first computing device, the first input from the database in response to said receiving the second input;
communicating, with the first computing device, at least part of the first input to the third computing device in response to said receiving the second input; and
exchanging, with the third computing device, the physical article.

2. The method of claim 1 further comprising:
positioning a physical object in the drive-through lane at the exchange location;
scanning, with the second computing device, at least part of the physical object; and
wherein said receiving the second input is further defined as receiving the second input directly from the second computing device while the second computing device is positioned in the drive-through lane at the exchange location after said scanning.

3. The method of claim 2 wherein said positioning is further defined as:
positioning a quick response (QR) code along the drive-through lane at the exchange location, wherein an appearance of the QR code is configured to particularly identify the exchange location from a plurality of different locations and the QR code is scanned during said scanning.

4. The method of claim 1 further comprising:
positioning a near field communication device along the drive-through lane at the exchange location;
receiving, with the near field communication device, a signal including the account associated with the user from the second computing device;
communicating, with the near field communication device, the account associated with the user to the third computing device; and
wherein said receiving the second input is further defined as receiving the account associated with the user as part of the second input from the third computing device at the exchange location.

5. The method of claim 1 further comprising:
positioning a near field communication device along the drive-through lane at the exchange location;
emitting, with the near field communication device, a signal including the exchange location; and
wherein said receiving the second input at the first computing device is further defined as receiving the second input from the second computing device.

6. The method of claim 1 further wherein said receiving the second input at the first computing device is further defined as receiving the second input from the second computing device.

7. The method of claim 1 wherein said storing is further defined as:
storing, with the first computing device, the first input in the database without associating the exchange location with the first input.

8. The method of claim 7 wherein the second input is at least partially received by the first computing device from the second computing device while the second computing device is positioned in the drive-through lane at the exchange location and the second input includes data associated with the exchange location.

9. The method of claim 1 wherein said exchanging step is further defined as:
exchanging, with the third computing device, the physical article with the user in response to said communicating the first input to the third computing device by the first computing device.

10. The method of claim 9 wherein said exchanging further comprises:
receiving, with the third computing device, the physical article from the user.

11. The method of claim 9 wherein said exchanging further comprises:
dispensing, with the third computing device, the physical article to the user.

12. The method of claim 9 wherein said exchanging is further defined as:
exchanging, with the third computing device, the physical article with the user in response to said communicating the first input to the third computing device by the first computing device without further authentication of the user.

13. The method of claim 9 further comprising:
authenticating, with the third computing device, the user prior to said exchanging and subsequent to said communicating the first input to the third computing device, said authenticating in response to details of the exchange of the physical article.

14. The method of claim 13 wherein said authenticating further comprises:
receiving, at the third computing device, a PIN number from the user.

15. The method of claim 13 wherein said authenticating further comprises:
receiving, at the third computing device, a card and a PIN number from the user.

16. The method of claim 13 wherein said authenticating further comprises:
receiving, at the first computing device, a third input from the second computing device after said receiving the second input, the third input confirming the identity of the user and the presence of the user at the exchange location.

17. The method of claim 1 further comprising:
receiving, at the first computing device, a third input from the second computing device substantially concurrent with the first input, the third input indicating a current location of the user;
determining, at the first computing device, one or more exchange locations proximate to the current location; and
transmitting, with the first computing device, a message to the second computing device, the message including the one or more exchange locations.

18. A system for exchanging a physical article comprising:
a drive-through lane traversable by a vehicle and positioned at an exchange location;
a first computing device having one or more processors and a non-transitory, computer readable medium, said first computing device physically-spaced from said drive-through lane configured to communicate with a remote, second computing device possessed by a user;
a third computing device having one or more processors and a non-transitory, computer readable medium, said third computing device positioned along said drive-through lane at said exchange location remote from said first computing device; and
said non-transitory, computer readable medium of said first computing device storing instructions that, when executed by said one or more processors, cause said first computing device to perform operations including:
receiving a first input from the second computing device, the first input defining the pre-staged transaction and including details of the exchange of the physical article performed after receiving the first input and performed at said exchange location, the first input also including details of an account associated with the user;
storing the first input in a database;
receiving a second input including the account associated with the user and data associated with said exchange location, the second input and indicative of the user presently positioned at said exchange location;
retrieving the first input from said database in response to receiving the second input; and
communicating at least part of the first input to said third computing device in response to receiving the second input.

19. The system of claim 18 further comprising:
a locating marker positioned along said drive-through lane at said exchange location remote from said first computing device, said locating marker configured to convey details of said exchange location.

20. The system of claim 19 wherein said locating marker further comprises:
a quick response code positioned in said drive-through lane and proximate to said third computing device, said quick response code for scanning by the second computing device of the user when the user is in said drive-through lane.

21. The system of claim 19 wherein said locating marker further comprises:
a near field communication device positioned in said drive-through lane and proximate to said third computing device, said near field communication device configured to communicate with the second computing device when the user is in said drive-through lane.

22. The system of claim 19 wherein said locating marker is physically-spaced along said drive-through lane from said third computing device whereby the user is not able to engage said locating marker and said third computing device from the vehicle at the same position along said drive-through lane.
